(19) United States
(12) Patent Application Publication
(10) Pub. No.: US 2025/0323472 A1
(43) Pub. Date: Oct. 16, 2025

(54) DEADBREAK GROUNDING DEVICE

(71) Applicant: Hubbell Incorporated, Shelton, CT (US)

(72) Inventors: Joseph Todd Neville, Jackson, SC (US); David Charles Hughes, Aiken, SC (US)

(21) Appl. No.: 19/175,373

(22) Filed: Apr. 10, 2025

Related U.S. Application Data
(60) Provisional application No. 63/632,339, filed on Apr. 10, 2024.

(51) Int. Cl. H02B 1/16

(52) U.S. Cl. CPC H02B 1/16

(57) ABSTRACT

A grounding device for an electrical distribution system includes a housing having a central region, a first end extending from the central region, a second end extending from the central region, and a bore extending from the first end to the second end. A shank is positioned in the bore and extending from the first end into the central region. A bus insert is positioned in the shank. A canister extends from the second end into the central region. The canister includes a conductive material and having a first end electrically connected to the bus insert. A nose extends into the second end and at least partially into the canister. The nose includes an insulated material. A sleeve extends from the second end into the central region through the nose and at least partially through the canister.

### RELATED APPLICATION(S)

This application is based on U.S. Provisional Patent Application Ser. No. 63/632,339, filed Apr. 10, 2024, the disclosure of which is incorporated herein by reference in its entirety and to which priority is claimed.

### FIELD

Various exemplary embodiments relate to overvoltage protection assemblies for an electrical distribution system.

### BACKGROUND

Underground power distribution systems can utilize switchgear, transformers, and sectionalizing cabinets to provide enclosed access points. These enclosures can include a panel and a plurality of bushings extending from the panel. The bushing can be connected to loadbreak or deadbreak connectors, such as elbow or T-connectors, to allow for connection or disconnection of cables for service, repair or expansion of the system.

### SUMMARY

In certain configurations, a grounding device for an electrical distribution system includes a housing having a central region, a first end extending from the central region, a second end extending from the central region, and a bore extending from the first end to the second end. A shank is positioned in the bore and extending from the first end into the central region. A bus insert is positioned in the shank. A canister extends from the second end into the central region. The canister includes a conductive material and having a first end electrically connected to the bus insert. A nose extends into the second end and at least partially into the canister. The nose includes an insulated material. A sleeve extends from the second end into the central region through the nose and at least partially through the canister.

In certain configurations, a grounding device for an electrical distribution system includes a housing having a central region, a first end extending from the central region, a second end extending from the central region, and a bore extending from the first end to the second end. A shank is positioned in the bore and extending from the first end into the central region. A bus insert is positioned in the shank. A canister extends from the second end into the central region. The canister includes a conductive material and having a first end electrically connected to the bus insert. A nose extends into the second end and at least partially into the canister. The nose includes an insulated material. A sleeve extends from the second end into the central region through the nose and at least partially through the canister. A cap is configured to be positioned over the second end of the housing The cap includes an inner chamber, an outer conductive layer, an inner conductive layer, an insulation layer positioned at least partially between the outer conductive layer and the inner conductive layer, and a fastener extending through the inner chamber. The fastener is configured to threadably engage the bus insert.

Certain implementations are directed to a method of utilizing a grounding device in an electrical distribution system. A grounding device is connected to a bushing in an electrical system enclosure. The grounding device has a housing, a shank positioned in the housing for connecting to a bushing, a bus insert positioned in the shank, a canister extending into shank and electrically connected to the bus insert, an insulated nose extending into the canister, and a sleeve extending into the canister and the nose. Power to the enclosure is disconnected. A probe is inserted through the sleeve and into contact with the bus insert to determine if power is present in the enclosure.

### BRIEF DESCRIPTION OF THE DRAWINGS

The aspects and features of various exemplary embodiments will be more apparent from the description of those exemplary embodiments taken with reference to the accompanying drawings.

FIG. 1 is a schematic drawing of an electrical distribution enclosure.

FIG. 2 is a perspective view of an exemplary grounding device.

FIG. 3 is a side, sectional view of the grounding device of FIG. 2.

FIG. 4 is a side, sectional view of the housing of the grounding device of FIG. 2.

FIG. 5 is a side view of the shank and bus insert of the grounding device of FIG. 2.

FIG. 6 is a section view of FIG. 5.

FIG. 7 is a side view of the canister, sleeve, and nose of the grounding device of FIG. 2.

FIG. 8 is a sectional view of FIG. 7.

FIG. 9 is a side view of the grounding device of FIG. 2 and an exemplary cap.

FIG. 10 is a side, sectional view of the cap of FIG. 9.

FIG. 11 is a side view of the grounding device of FIG. 2 and an exemplary grounding rod.

### DETAILED DESCRIPTION OF EXEMPLARY EMBODIMENTS

In underground power transmission systems, T-connectors can be used to terminate connections in switchgear, transformers, and sectionalizing cabinets (e.g., a feedthrough transformer, a vault transformer, a pad-mounted transformer, a direct-buried transformer, a submersible transformer, and the like). The enclosure can include a front panel positioned at the end of an underground cable run. A plurality of insulated bushings can extend through the panel to provide connection and termination points. Connectors, such as elbow and T-connectors, can be connected to the bushings.

In certain instances, it can be necessary to safely ground the connections to the bushings. Grounding such connections, however, becomes more difficult when greater amperage is involved. For example, grounding tap devices for 200 A loadbreaks can utilize internal contacts that are rated for faults of 10 kA or less. These devices, however, cannot be used to safely ground 600 or 900 A systems with fault currents above 10 kA.

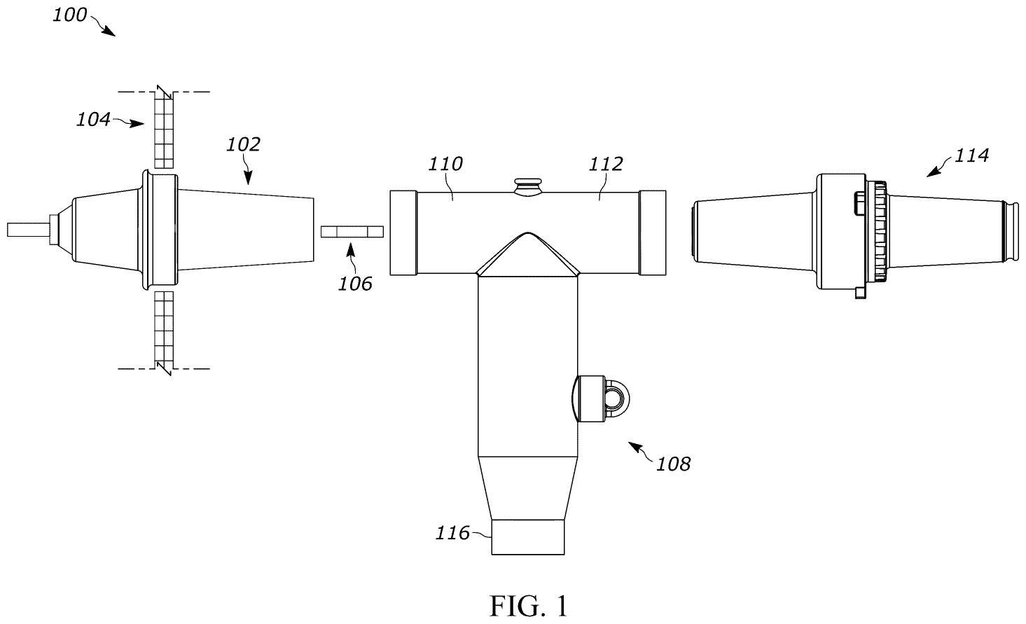

FIG. 1 shows an exemplary schematic implementation of a distribution system 100 utilizing a transformer enclosure with a bushing 102 extending through a front panel 104. The bushing 102 can be connected to a power supply. A threaded stud 106 can be connected to the bushing 102. A T-connector 108 includes a first end 110 for mating with the bushing 102 and a second end opposite 112 the first end 110. The second end 110 receives a grounding device 114 and can mate with other connectors, such as an elbow connector or grounding clamp. A transformer cable can be connected to the base 116 of the T-connector.

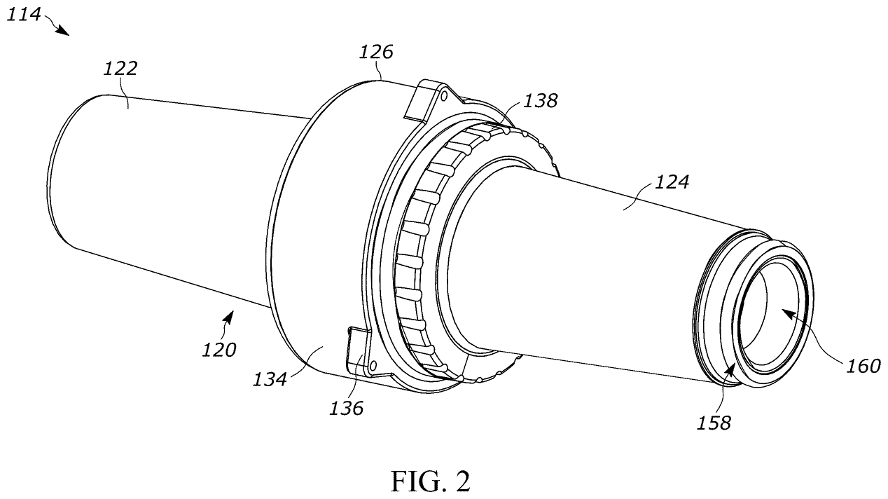

FIGS. 2-8 show an exemplary configuration of the grounding device 114. The grounding device 114 can include a housing 120 having a first end 122, a second end 124, and a central portion 126. The first end 122 can be configured to connect to the transformer bushing and the second end 124 is configured to provide an energized interface connection, for example to a cap or grounding rod. The housing 120 can be made from an insulated material, such as a non-conductive rubber or epoxy material.

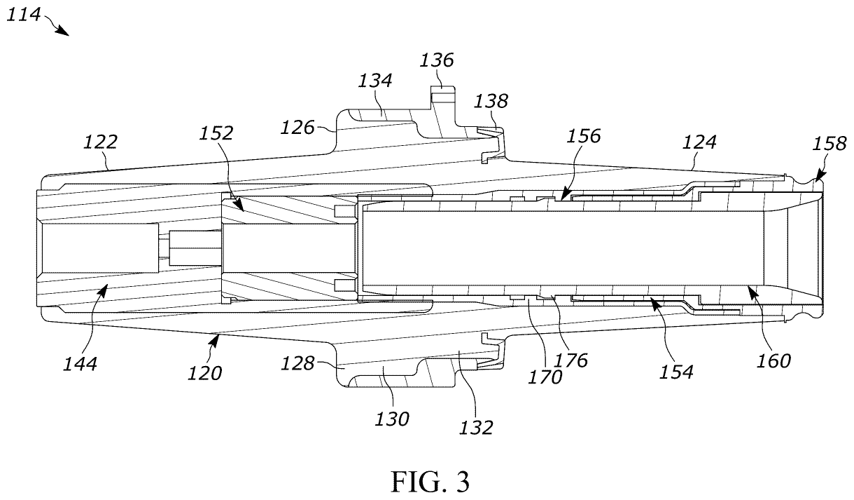

The first end 122 and the second end 124 of the grounding device housing 120 has a frusto-conical configuration that tapers from the central portion 126 to the open ends. The central portion 126 has a substantially cylindrical configuration with an outer diameter that extends beyond the bases of the first and second ends 122, 124. As best shown in FIG. 3, the central portion 126 can include an outer rim 128, a first body section 130 having a diameter less than the outer rim 128 and a second body section 132 having a diameter less than the first body section 130.

The central portion 126 can include a collar 134 made from a conductive or semi-conductive material. In certain configurations, the collar 134 is seated against the rim 128 and molded over the first and second body sections 132, 134. One or more protrusions 136 can extend from the collar 134 to provide connection points for drain wires.

A ring 138 can be positioned in front of the collar 134 toward the second end 124. The ring 138 can provide latch indication so that a user knows when a connecting device is fully seated on the second end 124. In certain configurations, the collar 134 and ring 138 can be integrally molded with the remainder of the housing 120.

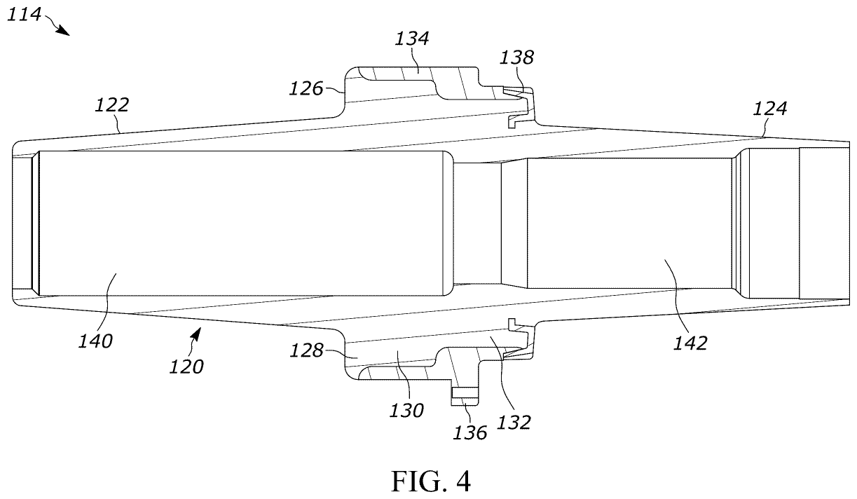

As best shown in FIG. 4, the interior of the housing includes a through bore having a first chamber 140 and a second chamber 142. The first chamber 140 extends from the first end 122 into the central region 126 and the second chamber 142 extends from the second end 124 into the central region 126. The second chamber 142 can have a wider lead in sections extending from the opening. The first and second chambers 140, 142 receive one or more interior components to form a shielded conductive path through the insulated housing.

In certain configurations, a shank 144 can be positioned in the first chamber 140. As best shown in FIG. 2, the shank 144 can extend from the first end into the central region. The shank 144 can be made from a conductive material to provide an electrical path from the transformer bushing.

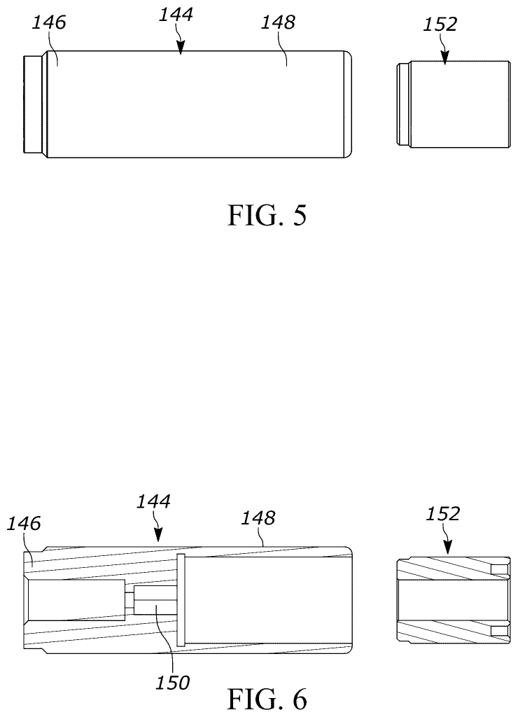

As shown in FIGS. 5 and 6, the shank 144 can include a first open end 146 and a second open end 148. The shank 144 can include a hex interface 150. The hex interface 150 can be used to rotate the grounding device onto the threaded stud of a bushing. The open first end 146 of the shank 144 can include a chamfered opening and an interior thread that is configured to mate with the transformer bushing.

A bus insert 152 can be received into the second end 148 of the shank. The bus insert 152 can have an external thread for threadably connecting to an aperture in the second end 148 of the shank 144. An internal thread can be configured to threadably receive a component, such as a grounding bolt or cap as shown herein.

As best shown in FIG. 3, a contact assembly 154 can be positioned in the second chamber 142 and extend from the opening in the second end 124 into the central region 126. The contact assembly 154 can extend into the open second end 148 of the shank 144 and be in engagement with the bus cylinder 152. The contact assembly 154 can include a canister 156, an insulated nose 158, and an insulated sleeve 160.

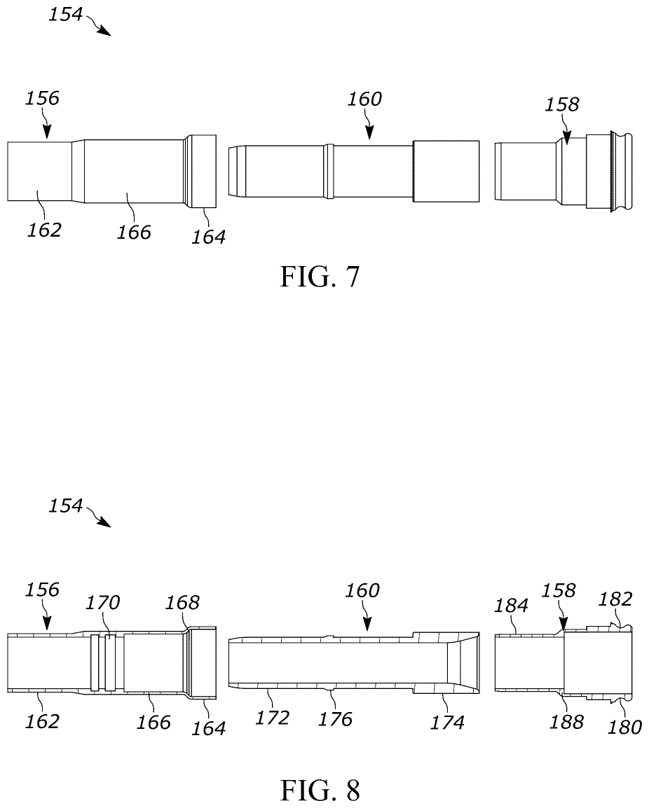

The canister 156 extends from inside the second end 124 of the housing 120 into the second end 148 of the shank 144. The canister 156 can be made from a conductive material. As best shown in FIGS. 7 and 8, the canister 156 can have a series of cylindrical sections including a first portion 162 with a first open end, a second portion 164 with a second open end, and a central portion 166 extending between the first portion 162 and second portion 164. The second portion 164 can have a larger outer diameter than the central portion 166 and the central portion 166 can have a larger outer diameter than the first portion 162. Other configurations can utilize different shapes and sizes for the canister.

A recessed rim 168 can be provided in the second portion 164 for receiving the nose 158. A set of ribs 170 can be provided on the interior of the central portion 166 to form a mating connection with the sleeve 160. The canister 156 is configured to extend at least partially into the shank 144 and to be electrically connected with the bus insert 152. In certain configurations, the canister 156 can be in direct engagement with the bus insert 152. The canister 156 provides electrical shielding to the interior of the housing 120 to prevent or limit arc damage to the housing 120.

The sleeve 160 is configured to extend from outside of the open second end 124 of the housing 120 and into the canister 156. The sleeve 160 includes a series of cylindrical sections with a body 172 extending from a front portion 174. The front portion 174 has a larger outer diameter than the body 172. The front portion 174 includes a frusto-conical opening that tapers toward the body 172. A projection 176 extends from the body 172 and is configured to mate with the ribs 170 of the canister 156. In certain configurations, the projection 176 is an annular ring that extends around the body 172. The projection 176 can include an angled leading edge to enable easier insertion and mating of the sleeve 160 with the canister 156.

The nose 158 is configured to extend from the open second end 124 of the housing 120 and into the canister 156. The nose 158 includes a series of cylindrical sections with a first section 180 positioned at least partially outside of the housing. The first section 180 can include a groove 182 extending around the opening. An outer rim 186 can engage the canister 156. A second section 184 extends from the first section 180 and forms an inner rim 188 for receiving the sleeve 160.

In certain configurations, the canister 156, sleeve 160, and nose 158 are coaxial with one another. The front portions of the nose 158 and the sleeve 160 extend outside of the housing 120 and cover the outer end of the canister 156. The nose 158 and the sleeve 160 extend into the canister 156, with the sleeve 160 extending substantially the length of the canister 156, leaving a small gap of the exposed canister 156 adjacent the bus insert 152. The sleeve 160 and the nose 158 substantially insulate the canister and the bus insert 152, allowing a through opening so that a test probe, grounding clamp, or other device can be inserted into the grounding device and connected to the bus insert 152.

During operation, a user can shut off the power to the transformer downstream and then test the grounding device 114 to ensure that power is no longer live in the enclosure. A loadbreak probe can be inserted into the grounding device 114, with the tip of the probe extending into the through bore in the sleeve 160. The probe will extend through the sleeve 160 until it makes contact with the bus insert 152.

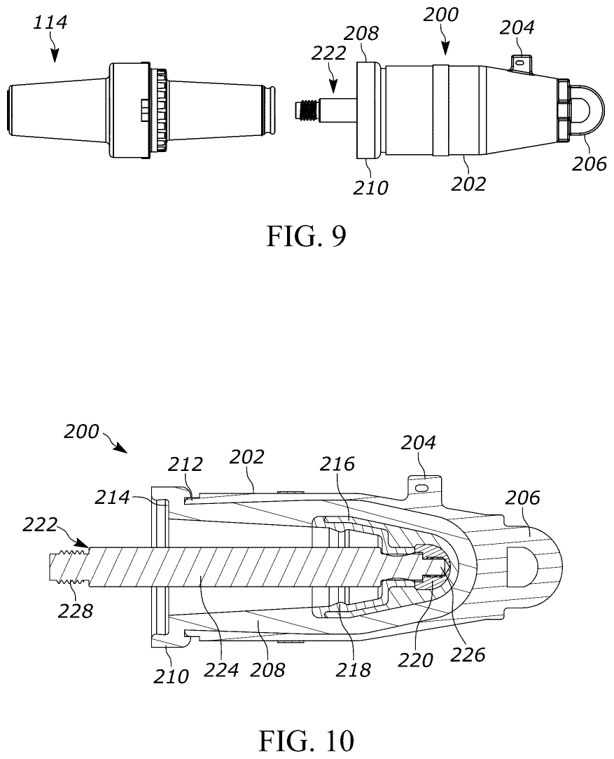

FIGS. 9 and 10 show an exemplary configuration of a cap 200 that can be positioned on the second end of the grounding device 114. The cap 200 includes an outer shell 202. The outer shell 202 can be made from a conductive material, such as a conductive rubber. One or more protrusions 204 can extend from the outer shell 202 to provide connection points for drain wires. An eye 206 is provided on the outer shell 202 so that the cap 200 can be installed with a hot stick.

The cap 200 can also include an insulation layer 208 positioned beneath the outer shell 202. The insulation layer 208 extends around the interior of the outer shell 202 and can include a rim 210 that at least partially defines an opening. The rim 210 can have an outer channel 212 receiving the end of the outer shell 202 and an inner seat 214. The rim 210 can have a larger outer diameter than the end of the outer shell 202. The inner seat 214 can be configured to engage the ring 138 of the housing 120 with the rim 210 covering the ring 138 so that a user knows the cap 200 has been fully engaged with the grounding device 114.

The cap 200 can also include an inner conductive layer 216. The inner conductive layer 216 can be made from a conductive or semi-conductive material such as a conductive rubber. The inner conductive layer 216 helps shield the outer conductive layer 202. Positioned inside of the inner conductive layer is an insulated layer 218 and a boss 220. The insulated layer 218 can be insulated rubber and the boss 220 can be made from a metallic material.

The boss 220 is configured to receive a fastener 222 that extends through the interior of the cap 200. The fastener 222 can include a shaft 224, an inner threaded section 226, and an outer threaded section 228. The inner threaded section 226 is configured to threadably mate with the boss 220, although other types of connections, including press-fit connections, can also be used. The outer threaded section 228 is configured to threadably mate with the inner thread of the bus insert 152.

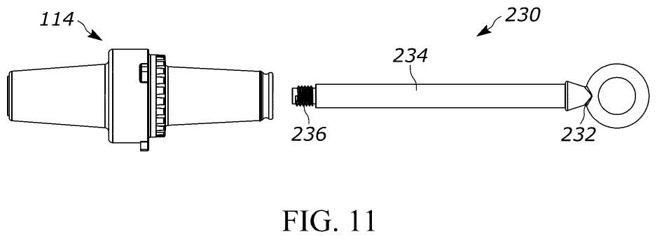

FIG. 11 shows an exemplary configuration of a grounding interface 230 that can be connected to the grounding device 114. The grounding interface 230 includes a head 232 having an eye and a shaft 234 extending from the head 232. The shaft 234 can have a threaded portion 236 for threadably connecting to the bus insert 152. The eye can receive a grounding clamp or other grounding device. Other configurations, including a ball interface rod can also be used.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. A grounding device for an electrical distribution system comprising:
a housing having a central region, a first end extending from the central region, a second end extending from the central region, and a bore extending from the first end to the second end;
a shank positioned in the bore and extending from the first end into the central region;
a canister extending from the second end into the central region, the canister including a conductive material and having a first end electrically connected to the shank;
a nose extending into the second end and at least partially into the canister, the nose including an insulated material; and
a sleeve extending from the second end into the central region through the nose and at least partially through the canister.

2. The grounding device of claim 1, wherein at least a portion of the nose is positioned between the sleeve and the canister and at least a portion of the canister is positioned between the sleeve and the housing.

3. The grounding device of claim 1, wherein the sleeve and the canister extend into the shank.

4. The grounding device of claim 1, wherein the shank includes a first end having a first opening and a second end having a second opening, wherein the first opening has a threaded member configured to connect to a transformer bushing.

5. The grounding device of claim 1, wherein the canister includes a set of ribs and the sleeve includes a projection configured to mate with the ribs.

6. The grounding device of claim 1, wherein the central region of the housing includes a conductive collar.

7. The grounding device of claim 1, further comprising a bus insert positioned in the shank.

8. The grounding device of claim 1, wherein the sleeve includes a first end spaced from the bus insert.

9. The grounding device of claim 1, wherein the nose and the sleeve are at least partially positioned outside of the second end of the housing.

10. The grounding device of claim 1, further comprising a cap connected to the housing.

11. The grounding device of claim 10, wherein the cap includes a fastener threadably connected to the bus insert.

12. A grounding device for an electrical distribution system comprising:
a housing having a central region, a first end extending from the central region, a second end extending from the central region, and a bore extending from the first end to the second end;
a shank positioned in the bore and extending from the first end into the central region;
a canister extending from the second end into the central region, the canister including a conductive material and having a first end electrically connected to the shank;
a nose extending into the second end and at least partially into the canister, the nose including an insulated material;
a sleeve extending from the second end into the central region through the nose and at least partially through the canister; and
a cap configured to be positioned over the second end of the housing, the cap including an inner chamber, an outer conductive layer, an inner conductive layer, an insulation layer positioned at least partially between the outer conductive layer and the inner conductive layer, and a fastener extending through the inner chamber,
wherein the fastener is configured to threadably engage the shank.

13. The grounding device of claim 12, wherein the cap includes a threaded boss and the fastener is threadably connected to the boss.

14. The grounding device of claim 12, further comprising a bus insert positioned in the shank.

15. The grounding device of claim 14, wherein the cannister is directly engaged with the bus insert.

16. The grounding device of claim 12, wherein the canister includes a set of ribs and the sleeve includes a projection configured to mate with the ribs.

17. A method of utilizing a grounding device in an electrical distribution system comprising:
connecting a grounding device to a bushing in an electrical system enclosure, the grounding device having a housing, a shank positioned in the housing for connecting to a bushing, a bus insert positioned in the shank, a canister extending into shank and electrically connected to the bus insert, an insulated nose extending into the canister, and a sleeve extending into the canister and the nose;
disconnecting power to the enclosure; and
inserting a probe through the sleeve and into contact with the bus insert to determine if power is present in the enclosure.

18. The method of claim 17, wherein connecting the grounding device to the bushing includes positioning the grounding device in a T-connector and connecting the T-connector to the bushing.

19. The method of claim 17, further comprising threadably connecting a grounding rod to the bus insert.

20. The method of claim 17, further comprising removing a cap threadably connected to the bus insert.
